(19) United States
(12) Patent Application Publication
(10) Pub. No.: US 2026/0180750 A1
(43) Pub. Date: Jun. 25, 2026

(54) APPARATUS AND METHODS FOR ENABLING CARRIER AGGREGATION IN FULL DUPLEX MODE

(71) Applicant: InterDigital Patent Holdings, Inc., Wilmington, DE (US)

(72) Inventors: Aata El Hamss, Laval (CA); Jonghyun Park, Syosset, NY (US); Moon IL Lee, Melville, NY (US); Paul Marinier, Brossard (CA); Nazli Khan Beigi, Longueuil (CA); Virgile Garcia, Antibes (FR)

(73) Assignee: InterDigital Patent Holdings, Inc., Wilmington, DE (US)

(21) Appl. No.: 18/990,457

(22) Filed: Dec. 20, 2024

(51) Int. Cl. H04L 5/00; H04L 5/14; H04W 24/10

(52) U.S. Cl. CPC H04L 5/0051; H04L 5/14; H04W 24/10

(57) ABSTRACT

A wireless transmit/receive unit (WTRU) receives configuration information messages regarding sub-band full duplex (SBFD) carriers, including SBFD configuration information, including for each of the one or more SBFD carriers: time units; downlink subbands, uplink subbands, or both, for each of the times units; and sounding reference signal (SRS) configurations for reception and for transmission. The WTRU receives indication information regarding SRS resources for non-activated carriers of the SBFD carriers. The WTRU monitors SRSs associated with the non-activated carriers, based on the respective SRS configuration for reception of the non-activated carriers and the indication information. The WTRU transmits SRSs associated with the non-activated carriers, based on the respective SRS configuration for transmission of each of the non-activated carriers and the indication information. The WTRU receives a request to report SRS measurements for the SRSs, and reports a set of carriers with SRS measurements with results below or equal to a threshold.

### BACKGROUND

Current wireless communications systems include two modes of operation: Frequency Division Duplex (FDD) mode and Time Division Duplex (TDD) mode. In FDD mode, downlink (DL) and uplink (UL) transmissions can be configured at the same time but using different carrier frequencies. In TDD mode, the DL and UL transmissions are separated in time domain. This time restriction can limit the data throughput especially for uplink transmissions. To solve this limitation of the resource availability in one direction (DL or UL), full duplex was studied to be supported in new radio (NR) systems.

Full duplex consists of having base station or gNB, and/or wireless transmit/receive unit (WTRU), transmit and receive in the same carrier bandwidth at the same time. In the 3^{rd} Generation Partnership Project (3GPP) full duplex study, a sub-band full duplex (SBFD) concept was introduced where a carrier is divided into multiple sub-bands and each sub-band will have transmissions in only one direction. For example, one SBFD configuration could be to divide a carrier into three sub-bands, with a first sub-band configured for downlink transmission, a second sub-band configured for uplink transmission and a third sub-band configured for downlink transmission. The three sub-bands can be separated by a gap in the frequency domain to protect the transmissions from cross link interference (CLI).

### SUMMARY

Disclosed herein are apparatus and methods for enabling carrier aggregation in full duplex mode, include sub-band full duplex (SBFD). In an example, a wireless transmit/receive unit (WTRU) receives one or more configuration information messages regarding one or more SBFD carriers, including SBFD configuration information. Further, the SBFD configuration information includes, for each of the one or more SBFD carriers: time units; one or more downlink subbands, uplink subbands, or both, for each of the times units; a sounding reference signal (SRS) configuration for reception; and an SRS configuration for transmission. The WTRU further receives indication information regarding SRS resources for one or more non-activated carriers of the one or more SBFD carriers.

The WTRU then monitors one or more first SRSs associated with the one or more non-activated carriers, based on the respective SRS configuration for reception of each of the non-activated carriers and the indication information. Also, the WTRU transmits one or more second SRSs associated with the one or more non-activated carriers, based on the respective SRS configuration for transmission of each of the non-activated carriers and the indication information.

In addition, the WTRU receives a request to report SRS measurements for the one or more first SRSs associated with the one or more non-activated carriers. Moreover, the WTRU reports a set of carriers, of the one or more non-activated carriers, with SRS measurements for the one or more first SRSs associated with the one or more non-activated carriers with results below or equal to a threshold.

In further examples, the indication information is received via one or more of: radio resource control (RRC) signaling, a medium access control (MAC) control element (CE), or downlink control information (DCI). Additionally or alternatively, the SRS measurements include one or more SRS-reference signal received power (RSRP) measurements, cross link interference (CLI)-reference signal strength indicator (RSSI) measurements, or both.

In a further example, the WTRU receives configuration information regarding reporting the SRS measurements using an uplink resource within a non-activated carrier of the one or more non-activated carriers, wherein the SRS measurements are reported, based on the configuration information regarding reporting the SRS measurements, using the uplink resources within the non-activated carrier of the one or more non-activated carriers. Additionally or alternatively, the WTRU receives configuration information regarding reporting the SRS measurements using an activated carrier, wherein the SRS measurements are reported, based on the configuration information regarding reporting the SRS measurements, using the activated carrier.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a configuration diagram illustrating an example of carrier aggregation with a sub-band full duplex (SBFD) configuration;

FIG. 3 is a configuration diagram illustrating an example of an SBFD configuration; and

FIG. 4 is a flowchart diagram illustrating an example of preventing the activation of a carrier for a WTRU which will create a high level of cross link interference (CLI) to other WTRUs.

### DETAILED DESCRIPTION

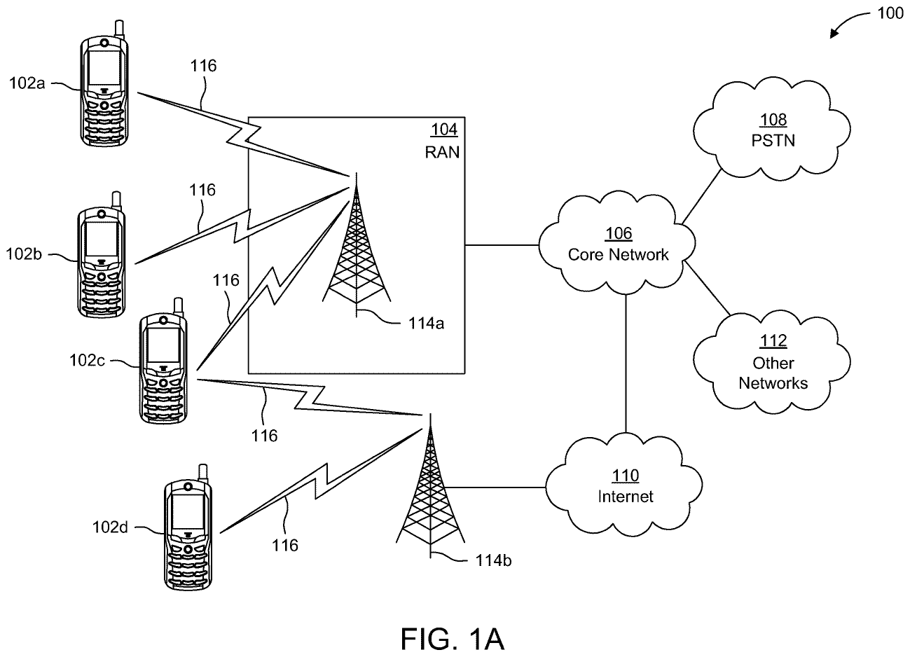

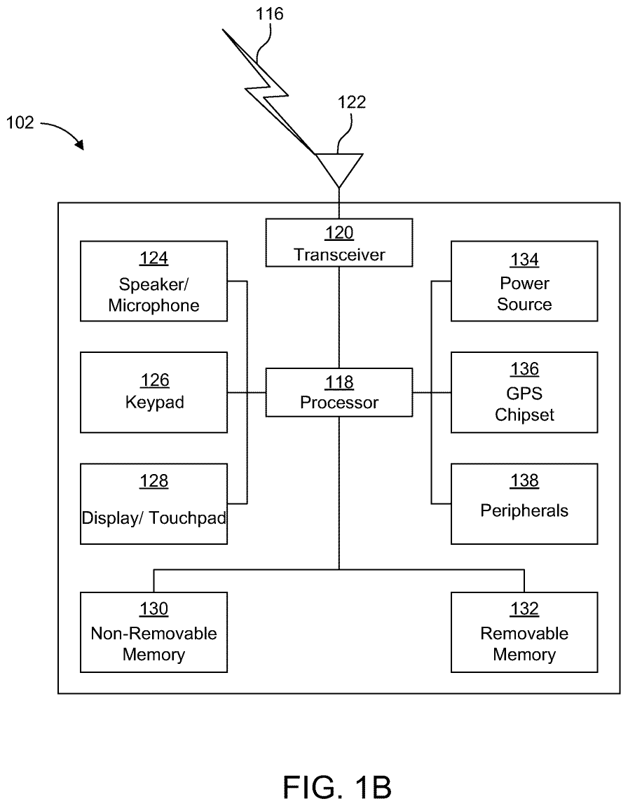

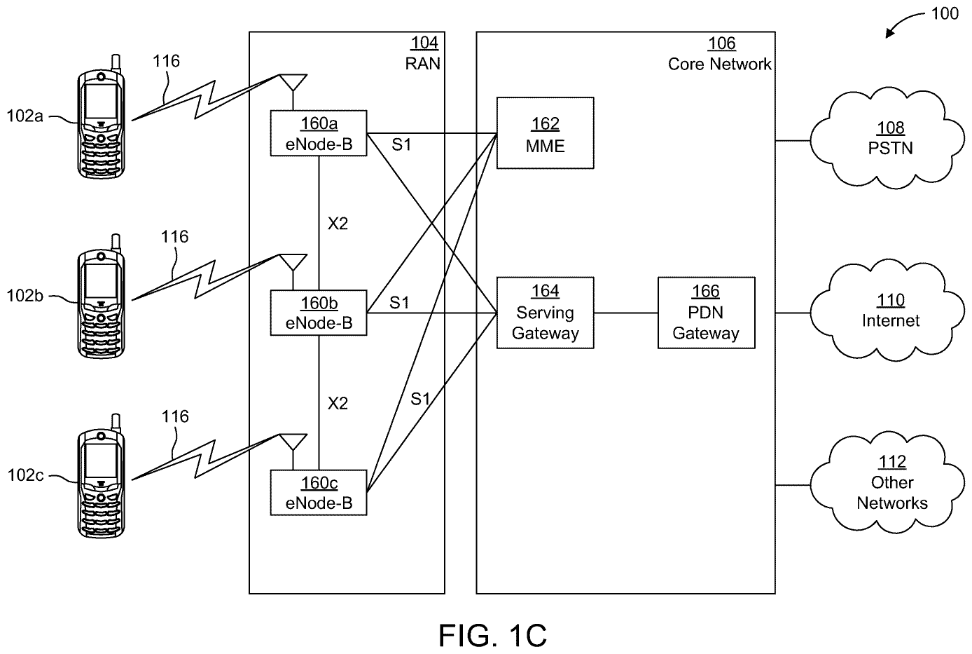

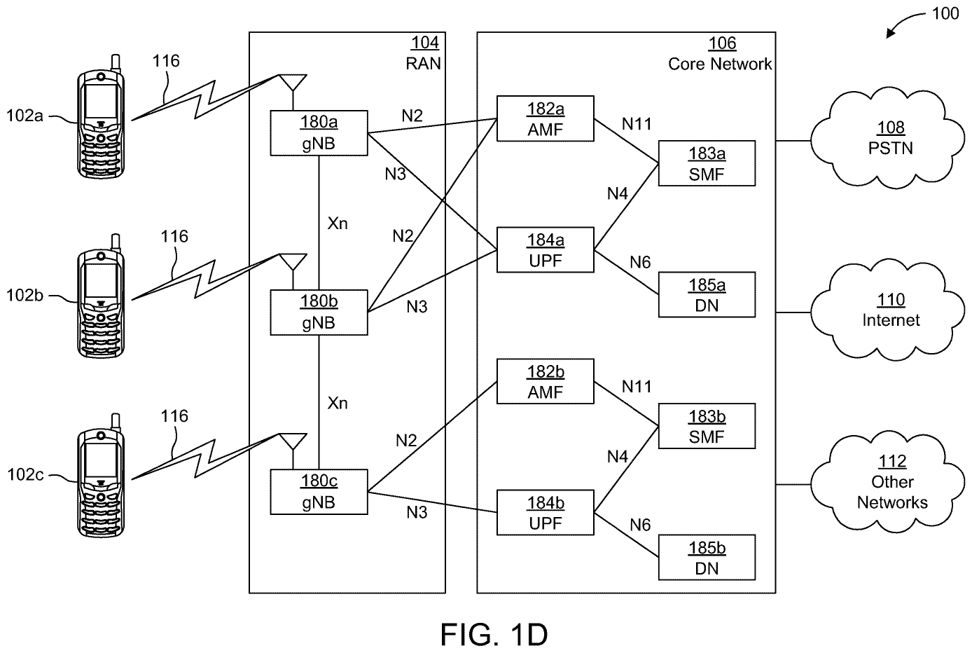

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3^{rd} Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Current wireless communications systems include two modes of operation: Frequency Division Duplex (FDD) mode and Time Division Duplex (TDD) mode. In FDD mode, DL and UL transmissions can be configured at the same time but using different carrier frequencies. In TDD mode, the DL and UL transmissions are separated in time domain. This time restriction can limit the data throughput especially for uplink transmissions. To solve this limitation of the resource availability in one direction (DL or UL), full duplex was studied to be supported in NR systems.

Full duplex consists of having base station or gNB and/or WTRU transmit and receives in the same carrier bandwidth at the same time. In the 3GPP full duplex study, sub-band full duplex (SBFD) concept was introduced where a carrier is divided into multiple sub-bands and each sub-band will have transmissions in only one direction. For example, one SBFD configuration could be to divide a carrier into three sub-bands, with a first sub-band configured for downlink transmission, a second sub-band configured for uplink transmission and a third sub-band configured for downlink transmission. The three sub-bands can be separated by a gap in frequency domain to protect the transmissions from cross link interference (CLI).

Carrier aggregation can further increase the available bandwidth for uplink transmissions in TDD mode. Multiple carriers can be configured for the WTRU to achieve high data throughput. Combining full duplex and carrier aggregation can offer more bandwidth and allows more opportunities for uplink transmissions in TDD mode.

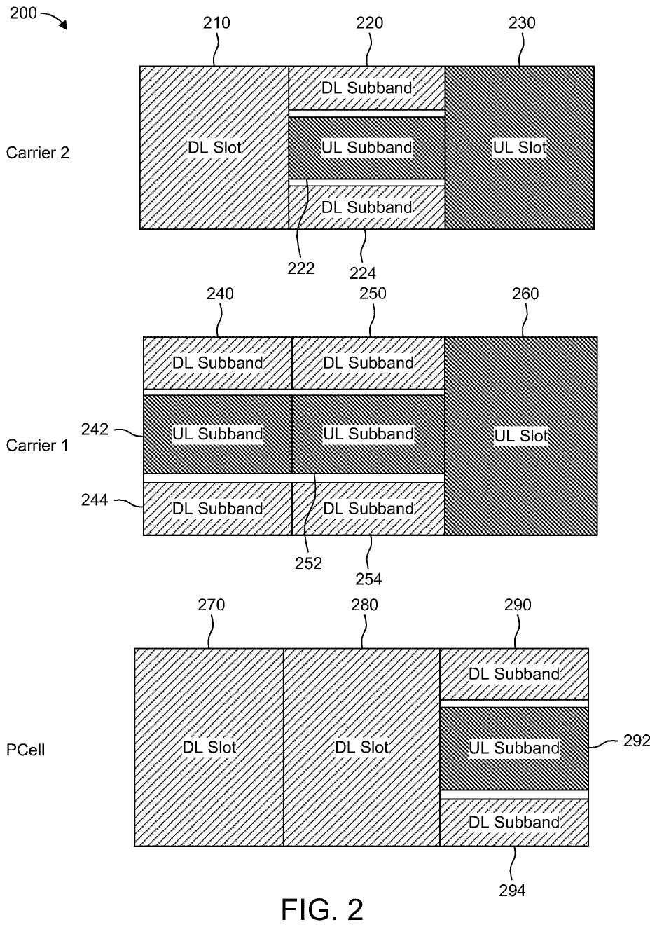

FIG. 2 is a configuration diagram illustrating an example of carrier aggregation with an SBFD configuration. As shown in an example in configuration diagram 200, a primary cell (PCell) has a first undivided DL slot 270, a second undivided DL slot 280 and a third slot divided into three sub-bands, with a first sub-band configured as a DL subband 290, a second sub-band configured as a UL subband 292, and a third sub-band configured as a DL subband 294.

Also, two carriers may be aggregated with the PCell, such as Carrier 1 and Carrier 2. Carrier 1 may have one undivided slot and two slots divided into three sub-bands each. For example, the first slot in Carrier 1 is divided into DL subband 240, UL subband 242 and DL subband 244. Further, the second slot in Carrier 1 is divided into DL subband 250, UL subband 252 and DL subband 254. The undivided slot of Carrier 1 is UL slot 260. Carrier 2 may have two undivided slots and one slot divided into three sub-bands. For example, the first slot in Carrier 2 is DL slot 210, and the second slot in Carrier 2 is divided into DL subband 220, UL subband 222 and DL subband 224. Further, UL slot 230 of Carrier 2 is undivided.

In an example, a first WTRU may transmit on UL subband 242 and a second WTRU may receive on DL subband 244. Further, the transmissions of the first WTRU on UL subband 242 may cause CLI with reception by the second WTRU on DL subband 244.

Enabling full duplex carrier for a WTRU to transmit/receive can create cross link interference to other WTRUs and/or suffer from cross link interference from other WTRUs. The current mechanism to activate a carrier enables the WTRU to monitor downlink control signaling, but then it may not be feasible or efficient based on an existing mechanism that the network assesses whether the WTRU could create cross link interference for other WTRUs or suffer interference from other WTRUs. When the WTRU activates a carrier, the WTRU should monitor possible scheduling and perform network measurements. The base station or gNB may determine that the carrier should be deactivated without any scheduling, leading to an increase in the WTRU's effort without benefit. Accordingly, wireless communication efficiency would increase by answering how to avoid activating a carrier for a WTRU that will create a high level of cross link interference to other WTRUs.

Embodiments and examples are provided here in of apparatus and methods for activating an SBFD carrier for a WTRU based on the level of cross link interference that the WTRU can experience and/or cause for other WTRUs. The WTRU transmits a sounding reference signal (SRS) and/or receives SRS in a carrier without activating the carrier. In examples, the WTRU transmits SRS and/or receives SRS across one or multiple time slots or time instances.

In an example, a WTRU is configured with a one or multiple carriers for possible data transmission and/or reception, where each carrier is configured with one or more of the following. Each carrier may be configured with an SBFD configuration that includes one or more DL sub-bands, one or more UL sub-bands, and the applicable slots/symbols, or other time units, for the SBFD configuration. Additionally or alternatively, each carrier may be configured with an SRS resource configuration for transmission. Additionally or alternatively, each carrier may be configured with an SRS resource configuration for reception, such as receiving SRS from other WTRUs.

Further, the WTRU receives an indication from the network to transmit and/or monitor one or more SRS resources in one or multiple non-activated carriers. Additionally or alternatively, the WTRU may be indicated to transmit/monitor SRS using radio resource control (RRC) signaling, a MAC control element (CE) and/or downlink control information (DCI). Additionally or alternatively, the WTRU may be configured to stop transmitting/receiving SRS in one or more carriers after a timer expiry, if no carrier activation command is received.

Also, the WTRU transmits SRS and/or monitors SRS transmissions in one or more non-activated carriers. In addition, the WTRU receives a request to report the SRS measurement for one or more non-active or non-activated carriers. In an example, the SRS measurement is or includes an SRS-reference signal received power (RSRP) measurement. Additionally or alternatively, the SRS measurement is or includes CLI-reference signal strength indicator (RSSI). Additionally or alternatively, the WTRU may be configured to report SRS measurement results using an uplink resource within the non-active carrier. Additionally or alternatively, the WTRU may be configured to report SRS measurement results using an activated carrier.

Moreover, the WTRU reports the set of carriers with SRS measurement results below a configured threshold. Additionally or alternatively, the WTRU reports the set of carriers with SRS measurement results at configured threshold.

In examples provided herein, the WTRU transmits SRS and/or monitors SRS transmissions in non-activated carriers. Additionally or alternatively, in examples provided herein, the WTRU reports SRS measurements results of one or more non-active carriers.

Additionally or alternatively, in examples provided herein, the WTRU autonomously activates autonomously a carrier based on SRS measurement results. If the SRS-RSRP is below a configured threshold, the WTRU activates the carrier. Additionally or alternatively, if the SRS-RSRP is at a configured threshold, the WTRU activates the carrier. Additionally or alternatively, the WTRU indicates to the base station or gNB that the carrier is activated.

As shown in embodiments and examples provided herein, the network can avoid activating a carrier for a WTRU that can impact the link quality of other SBFD WTRUs. For example, a carrier can be activated for a WTRU only if it has low level of cross link interference. As a result, the embodiments and examples provided herein increase wireless communications efficiency, and decrease power consumption and interference.

As used in in embodiments and examples provided herein, ‘a’ and ‘an’ and similar phrases are to be interpreted as ‘one or more’ and ‘at least one.’ Similarly, any term which ends with the suffix ‘(s)’ is to be interpreted as ‘one or more’ and ‘at least one.’ The term ‘may’ is to be interpreted as ‘may, for example.’

A symbol ‘/’ (for example, forward slash) may be used herein to represent ‘and/or’, where for example, ‘A/B’ may imply ‘A and/or B’ or ‘A, B, or both A and B.’

As used in embodiments and examples provided herein, the term “subband” is used to refer to a frequency-domain resource and may be characterized by one or more of the following: a set of resource blocks (RBs); a set of resource block sets (RB sets), for example when a carrier has intra-cell guard bands; a set of interlaced resource blocks; a bandwidth part, or portion thereof; or a carrier, or portion thereof. For example, a subband may be characterized by a starting RB and number of RBs for a set of contiguous RBs within a bandwidth part. A subband may also be defined by the value of a frequency-domain resource allocation field and bandwidth part index. Further, herein, the terms non-active carrier and non-activated carrier may be used interchangeably and still be consistent with the embodiments and examples provided.

Embodiments and examples provided herein include subband-based full duplex. Hereinafter, the term SBFD is used to refer to a subband-wise duplex (for example, either UL or DL being used per subband) and may be characterized by at least one of the following: cross division duplex (for example, XDD, subband-wise FDD within a TDD band), subband-based full duplex (for example, full duplex as both UL and DL are used/mixed on a symbol/slot, but either UL or DL being used per subband on the symbol/slot), frequency-domain multiplexing (FDM) of DL/UL transmissions within a TDD spectrum, a subband non-overlapping full duplex (SBFD) (for example, non-overlapped sub-band full-duplex), a full duplex other than a same-frequency (for example, spectrum sharing, subband-wise-overlapped) full duplex, an advanced duplex method, for example, other than (pure) TDD or FDD, for example, partial in-band full duplex, subband overlapping full duplex, in-band full duplex (IBFD).

In the following examples, a property of a grant or assignment may consist of at least one of the following: a frequency allocation; an aspect of time allocation, such as a duration; a priority; a modulation and coding scheme; a transport block size; a number of spatial layers; a number of transport blocks; a transmission configuration indicator (TCI) state, channel state information (CSI)-reference signal (RS) indicator (CRI) or SRS resource indicator (SRI); a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

In the following examples, an indication by DCI may consist of at least one of the following: an explicit indication by a DCI field or by a radio network temporary identifier (RNTI) used to mask cyclic redundancy check (CRC) of the physical downlink control channel (PDCCH); an implicit indication by a property such as DCI format, DCI size, coreset or search space, Aggregation Level, first resource element of the received DCI (for example, index of a first Control Channel Element), where the mapping between the property and the value may be signaled by RRC signaling or a MAC CE.

Hereafter, a signal may be interchangeably used with one or more of following, but still be consistent with embodiments and examples provided herein: sounding reference signal (SRS); channel state information - reference signal (CSI-RS); demodulation reference signal (DM-RS); phase tracking reference signal (PT-RS or PTRS); or synchronization signal block (SSB). Further, hereafter a channel may be interchangeably used with one or more of following, but still be consistent with embodiments and examples provided herein: physical downlink control channel (PDCCH), physical downlink shared channel (PDSCH), physical uplink control channel (PUCCH), physical uplink shared channel (PUSCH), physical random access channel (PRACH), or the like.

Hereafter, downlink reception may be used interchangeably with Rx occasion, PDCCH, PDSCH, SRS transmission, or SSB reception, but still consistent with embodiments and examples provided herein. Hereafter, uplink transmission may be used interchangeably with Tx occasion, PUCCH, PUSCH, PRACH, or SRS transmission, but still consistent with embodiments and examples provided herein. Hereafter, RS may be interchangeably used with one or more of RS resource, RS resource set, RS port, RS port group, SSB, CSI-RS, SRS and DM-RS, but still consistent with embodiments and examples provided herein. Additionally or alternatively, RS may be interchangeably used with one or more of but still consistent with embodiments and examples provided herein. Hereafter, time instance may be interchangeably used with slot, symbol, subframe, or time unit, but still consistent with embodiments and examples provided herein.

Hereafter, UL-only and DL-only Tx/Rx occasions may interchangeably be used with legacy TDD UL or legacy TDD DL, respectively, and still consistent with embodiments and examples provided herein. In an example, the legacy TDD UL/DL Tx/Rx occasions may be the cases where SBFD is not configured and/or where SBFD is disabled.

Hereafter, a UL signal (for example, at least one of SRS, DMRS, PUSCH, PUCCH, PRACH, PTRS, and so forth) may be used interchangeably with a UL signal or channel, or a UL channel or signal, but still consistent with embodiments and examples provided herein. Hereafter, a DL signal (for example, at least one of CSI-RS, SSB, PDSCH, PDCCH, physical broadcast channel (PBCH), PTRS, SRS and so forth) may be used interchangeably with a DL signal or channel, or a DL channel or signal, but still consistent with embodiments and examples provided herein.

The WTRU may be configured with SBFD in a frequency domain configuration. The SBFD frequency domain configuration may be associated with a carrier frequency. Additionally or alternatively, the SBFD frequency domain configuration may be associated with a Bandwidth Part (BWP) of a carrier frequency. The SBFD frequency domain configuration can allocate some RBs of the BWP/carrier for Uplink transmission and other RBs of the BWP/carrier for Downlink transmission. The WTRU can be configured with the SBFD frequency domain configuration using dedicated RRC signaling or common broadcasted signaling for example, system information block (SIB) signaling.

Hereafter, the RB(s) or resource elements (REs) may be interchangeably used with RE(s), RB(s), resource element group(s) REG(s), resource block group(s) RBG(s), frequency-unit(s), subband(s), band(s), BWP(s), component carrier(s), and so forth, but still consistent with embodiments and examples provided herein. For example, any frequency-domain granularity as a frequency-unit may be applicable in terms of whether full duplex (for example, SBFD) operation may be performed on one or more frequency-units.

The WTRU may be configured with a time domain configuration that indicates a slots configuration for SBFD, such as an SBFD time domain configuration. For example, the WTRU is configured with a first set of slots that have only SBFD symbols, a second set of slots that have only non-SBFD symbols (for example, symbols where the entire BWP or the carrier is for configured for either UL or DL) and a third set of slots that have both SBFD and non-SBFD symbols. The WTRU can be configured with SBFD time domain configuration using dedicated RRC signaling or common broadcasted signaling for example, SIB signaling.

Hereafter, the slot(s) or symbol(s) may be interchangeably used with symbol(s), slot(s), sub-frame(s), frame(s), time-unit(s), and so forth, but still consistent with embodiments and examples provided herein. For example, any time-domain granularity as a time-unit may be applicable in terms of whether full duplex (for example, SBFD) operation may be performed on one or more time-units.

In embodiments and examples provided herein, a cell may be interchangeably used with a carrier. Further, a PCell may be interchangeably used with a primary carrier, and still consistent with embodiments and examples provided herein. Further, a secondary cell (SCell) may be interchangeably used with a second carrier, and still consistent with embodiments and examples provided herein.

Examples are provided herein of full duplex configurations, such as SBFD configurations. In an example, a WTRU may receive one or more configurations for SBFD operation, as shown in in the following.

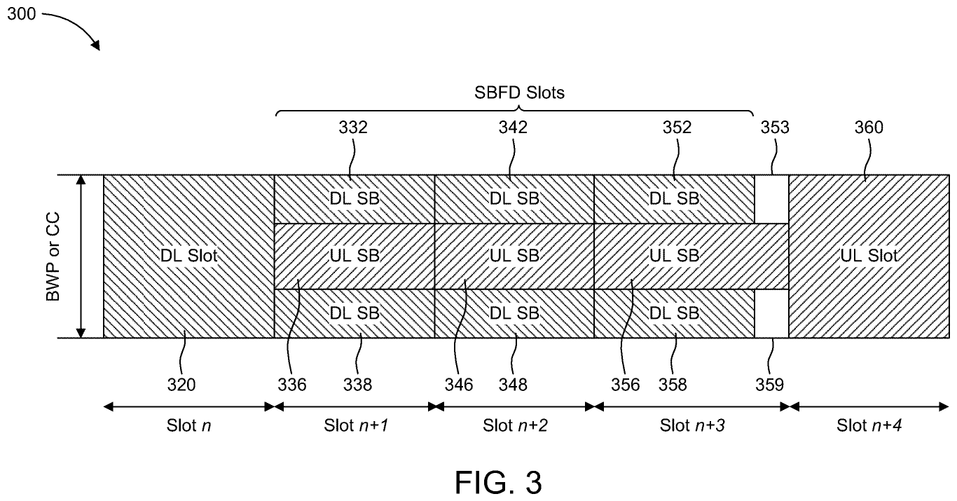

FIG. 3 is a configuration diagram illustrating an example of an SBFD configuration. The one or more configurations may include the information on time resources (for example, symbols, slots, and so forth) where the SBFD (for example, full duplex operation performed at the base station or gNB) is applied. The configurations may include the information on frequency resources in the configured SBFD time resources, for example for a first UL subband, a first DL subband, a first guard band, a first sidelink SB, a first Flexible SB, and so forth. In an example, the WTRU may receive the configurations via a DCI, MAC-CE, RRC, a system information block (SIB), a broadcast message, a multicast message toward a group of WTRUs, and so forth.

In an example, the WTRU may operate in half-duplex (HD) operation based on the configurations, where the WTRU may either transmit an UL (or sidelink) signal or receive a DL (or sidelink) signal in a configured (or indicated) SBFD time instance. In another example (for example, if configured by the base station or gNB), the WTRU may operate in full-duplex (FD) operation (for example, subband non-overlapping FD (SBFD), subband partially/fully-overlapping FD) using the first set of SBFD configurations, where the WTRU may both transmit an UL (or sidelink) signal and receive a DL (or sidelink) signal in a configured (or indicated) SBFD time instance.

In an example shown in configuration diagram 300, the SBFD configuration includes a DL Slot 320 in Slot n, which provides for DL transmission across the entire BWP or configured carrier (CC). Slot n is then followed by SBFD slots, Slot n+1, Slot n+2, and Slot n+3, each of which includes two DL subbands and one UL subband. Specifically, Slot n+1 includes DL subband 332, UL subband 336 and DL subband 338. Similarly, Slot n+2 includes DL subbands 342, 348 and UL subband 346; and Slot n+3 includes DL subbands 352, 358 and UL subband 356. Further, Slot n+4 includes a UL Slot 360, which provided for UL transmission across the entire BWP or CC.

Moreover, Slot n+3 may include guard symbols 353, 359, which may allow the WTRU to transition from using an SBFD slot to a non-SBFD slot. For example, the WTRU may receive in DL subband 352 in Slot n+3, an SBFD slot, and then, in Slot n+4, a non-SBFD slot, the WTRU may transmit in UL Slot 360. Guard symbol 353 separates DL subband 352 and UL Slot 360, allowing for the transition of the WTRU. Similarly, the WTRU may receive in DL subband 358 in Slot n+3, an SBFD slot, and then, in Slot n+4, a non-SBFD slot, the WTRU may transmit in UL Slot 360. Guard symbol 359 separates DL subband 358 and UL Slot 360, allowing for the transition of the WTRU.

A general configuration aspect for FD operation in the network is described herein. A WTRU may receive configurations (for example, from a base station or gNB, a node, or another device) for FD operation conducted by at least one device in a network. In an example, the FD operation may be conducted by a base station or gNB (for example, a BS, a node, a transmission-reception-point (TRP), a cell, or the like). The WTRU may operate in an HD mode for communicating with the base station or gNB, where the HD mode may imply at a given time that the WTRU either performs a UL transmission or a DL reception (not both simultaneously at the given time). The WTRU may (also) operate in an FD mode for communicating with the base station or gNB, for example, if corresponding WTRU capability signal(s) are reported to the base station or gNB and/or the WTRU receives a confirmation signal (for example, enabling the FD, configuring the FD mode, and so forth) in response to transmitting the WTRU capability signal(s).

The FD operation may imply at a given time a transmitter (for example, the base station or gNB and/or the WTRU) may simultaneously transmit a first signal and receive a second signal. The FD operation may comprise a subband overlapping FD (for example, in-band FD (IBFD)) operation where a first frequency-domain resource (for example, RBG(s), RB(s), RE(s), and the like) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (for example, assigned within a configured SBFD subband, for example, DL subband, usable DL physical resource blocks (PRBs)) does not have an overlap with a second frequency-domain resource allocated for the second signal (for example, assigned within a configured SBFD subband, for example, UL subband, usable UL PRBs).

Hereafter, for the brevity of discussion, the FD operation may comprise the SBFD operation, however the solutions and examples in the disclosure may equally (or equivalently or extendedly, and so forth) be employed (for example, be applicable) for cases with other FD operation types (for example, IBFD, and so forth). The WTRU may receive a configuration or indication of multiple FD operation types (for example, multiple FD symbol types), where a first, second, third (or more) FD operation types (for example, symbol types) may respectively indicate (for example, correspond to) a non-SBFD operation (or symbol) type, an SBFD operation (or symbol) type, an IBFD operation (or symbol) type, and so forth, based on the configuration or indication (for example, received from a BS, base station or gNB, cell, and/or TRP, and so forth).

A WTRU may receive SBFD-related configuration(s), for example, for frequency-domain location information of one or more subbands (for example, DL subband, UL subband, flexible DL/UL subband, and/or guardband), and/or for time-domain location information of the one or more subbands. The time-domain location information may indicate a set of non-SBFD symbols and a set of SBFD symbols (for example, as illustrated in FIG. 2). One or more symbols within the set of non-SBFD symbols may be a type of DL symbol, UL symbol or flexible symbol. The WTRU may receive a DL signal on one or more symbols based on a type of DL symbol in the set of non-SBFD symbols. The WTRU may transmit a UL signal on one or more symbols based on a type of UL symbol in the set of non-SBFD symbols. The WTRU may either receive a DL signal or transmit a UL signal on one or more symbols based on a type of flexible symbol in the set of non-SBFD symbols, for example, depending on one or more conditions with other signal(s) co-existing in the symbol(s).

In the following example solutions, a carrier may refer to a secondary cell (SCell).

Examples solutions are provided herein of carrier aggregation in full duplex mode. Further, examples are provided herein of an SBFD configuration for multiple carriers. One or multiple carriers can be configured for a WTRU to increase the data throughput. The configured carriers can be used for data transmission, data reception, or both. A WTRU may be configured with one or more SBFD time and frequency configurations in one or multiple carriers. The WTRU can receive an RRC configuration that indicates the SBFD time and/or frequency configurations for each of the carriers and the applicable slots/symbols for the SBFD configuration.

In one example solution, a WTRU may receive a common SBFD configuration for multiple carriers. For example, the SBFD configuration is common if the multiple carriers are in the same band (for example, intra-band carrier aggregation). In another solution, a WTRU may receive a different SBFD configuration for each carrier. The SBFD configuration per carrier can have different link direction and/or different UL/DL subband size. For example, the SBFD configuration is different if the multiple carriers are in different bands (for example, inter-band carrier aggregation). The SBFD configuration for each carrier can include different frequency gap(s) between UL sub-band(s) and DL sub-band(s). The frequency gap between the UL and DL sub-band(s) may depend on the WTRU capability and can be different for each WTRU.

Examples are provided herein of an SRS configuration for transmission in a non-active carrier. In some examples solutions, a WTRU may be configured with one or more SRS resources for transmission in a configured carrier. The SRS configuration can include time and frequency resources, periodicity of SRS transmission, frequency hopping of the SRS transmission, cyclic shift, transmission comb and SRS resource index. The SRS configuration can include a set of SRS resources, each one with specific parameters (for example, time/frequency/resource identity (ID)/cyclic shift). The SRS resource can span part of the carrier. The WTRU may transmit the configured SRS upon receiving an indication from the network to start transmitting. The network indication may trigger the WTRU to transmit multiple SRS resources. The WTRU may request the network to configure SRS based on SSB measurement(s). For example, the WTRU measures SSB of the carrier and determines that the RSRP is below a threshold. The WTRU then request the network to configure SRS for transmission. Additionally or alternatively, the WTRU measures SSB of the carrier and determines that the RSRP is equal to a threshold. The WTRU then requests the network to configure SRS for transmission.

Examples are provided herein of an SRS configuration for reception in a non-active carrier. In some example solutions, a WTRU may be configured with one or more SRS resources for reception in a configured carrier. The SRS configuration can include time and frequency resources, periodicity of SRS transmission, frequency hopping of the SRS transmission, cyclic shift, comb and SRS resource index. The SRS configuration can include a set of SRS resources, each one with specific parameters (for example, time/frequency/resource ID/cyclic shift). The SRS resource can span part of the carrier. The SRS resource may be limited to be configured in a UL (or DL) subband. In case the SRS resource spans also outside the UL (or DL) subband, the WTRU may determine a valid resource allocation (for example, in the frequency domain) of the SRS resource by removing (for example, truncating, ignoring, excluding) the resource allocation part outside the UL (or DL) subband. The WTRU may monitor the configured SRS upon receiving an indication from the network to start monitoring the SRS resource. The network indication may trigger the WTRU to monitor multiple SRS resources. When monitoring SRS transmission from other WTRUs, the WTRU may be configured to measure SRS-RSRP and/or received signal strength indicator (RSSI).

Examples are provided herein of CLI-RSSI measurement configuration for reception in a non-active carrier. In some example solutions, a WTRU may be configured with one or more CLI-RSSI resources for reception (for example, measurement) in a configured carrier, for example, which may be configured in addition to the above SRS configuration, where the WTRU may (be configured to) perform both (or either one) of SRS-RSRP measurements based on the SRS configuration and the CLI-RSSI measurement based on the CLI-RSSI resource(s). The CLI-RSSI configuration can include time and frequency resources, periodicity of the CLI-RSSI resource occasions, and a CLI-RSSI resource index. The CLI-RSSI configuration can include a set of CLI-RSSI resources, each one with specific parameters (for example, time/frequency/resource ID). The CLI-RSSI resource can span part of the carrier. The CLI-RSSI resource may be limited to be configured in a DL (or UL) subband. In case the CLI-RSSI resource spans also outside the DL (or UL) subband, the WTRU may determine a valid resource allocation (for example, in the frequency domain) of the CLI-RSSI resource by removing (for example, truncating, ignoring, excluding) the resource allocation part outside the DL (or UL) subband. The WTRU may monitor (for example, measure) the configured CLI-RSSI resource(s) upon receiving an indication from the network to start monitoring the CLI-RSSI resource(s). The network indication may trigger the WTRU to monitor (for example, measure) multiple CLI-RSSI resources.

Examples of carrier status are provided herein. When the WTRU is configured with carrier aggregation, each carrier can be set by the network in one or more different states. A first state, where the carrier is not enabled (i.e., deactivated carrier), the WTRU is not monitoring any transmission and not transmitting any transmission within the carrier. A second state, where the carrier is not enabled, the WTRU can monitor a reference signal transmission and can transmit a transmission within the carrier. For example, in the second state, the WTRU is not monitoring a PDCCH transmission for scheduling in the carrier but can transmit SRS and monitor SRS transmission from other WTRUs, and/or receive (for example, monitor, measure) the one or more CLI-RSSI resources. A third state, where the carrier is enabled (i.e., activated carrier), the WTRU is monitoring transmissions and can transmit within the carrier.

Examples of triggering SRS reception for cross link measurement are provided herein. The WTRU may be configured to receive an indication from the network that triggers monitoring of a configured SRS transmission in one or multiple non-activated carriers. For example, the WTRU can receive an RRC signaling that triggers monitoring of a configured SRS. In another example, the WTRU can receive a MAC CE that triggers monitoring of a configured SRS. The MAC CE can be carried in a PDSCH transmission in another carrier, which may be an activated carrier. In another example, the WTRU can receive DCI that triggers monitoring of a configured SRS. The DCI can be carried in a PDCCH transmission in another activated carrier. The network indication can trigger the monitoring of multiple SRS resources in one carrier and/or multiple carriers. For example, a bitfield in the DCI/MAC CE can trigger SRS monitoring in multiple carriers.

The WTRU may be configured with a timer to determine when to stop monitoring SRS transmission in a non-active carrier. The WTRU can stop monitoring SRS transmission if the carrier is not activated by the network and the timer expires. The WTRU starts a timer after receiving an indication to monitor SRS transmission in the non-active carrier. Upon the expiry of the timer, the WTRU stops monitoring SRS transmission(s) in the non active carrier. In one example solution, the WTRU may reset the timer if the WTRU determines that the measurement result is below or equal to a configured threshold. For example, the WTRU resets the timer when it measures SRS-RSRP and determines that the measurement result is below or equal to a configured threshold. In another example, the WTRU resets the timer when it measures CLI-RSSI and determines that the measurement result is below or equal to a configured threshold. In another example solution, the WTRU may reset the timer if the WTRU determines that the measurement result is above a configured threshold. The WTRU resets the timer when it measures SRS-RSRP and determines that the measurement result is above a configured threshold. In another example, the WTRU resets the timer when it measures CLI-RSSI and determines that the measurement result is above a configured threshold.

Examples of triggering CLI-RSSI measurements for cross link measurement are provided herein. The WTRU may be configured to receive an indication from the network that triggers measurements of one or more CLI-RSSI resources in one or multiple non-activated carriers, for example, which may be indicated in addition to the above SRS reception triggering. Further, the WTRU may (be configured or indicated to) perform both (or either one) of SRS-RSRP measurements based on the SRS configuration and the CLI-RSSI measurement based on the CLI-RSSI resource(s). For example, the WTRU can receive an RRC signaling that triggers measurements of the one or more CLI-RSSI resources. In another example, the WTRU can receive a MAC CE that triggers measurements of the one or more CLI-RSSI resources. The MAC CE can be carried in a PDSCH transmission in an activated carrier. In another example, the WTRU can receive DCI that triggers measurements of the one or more CLI-RSSI resources. The DCI can be carried in a PDCCH transmission in another activated carrier. The network indication can trigger the monitoring of multiple CLI-RSSI resources in one carrier and/or multiple carriers. For example, a bitfield in the DCI/MAC CE can trigger CLI-RSSI measurements in multiple carriers (for example, non-activated carriers or other states such as inactive, partially activated, or activated state of the carriers).

The WTRU may be configured with a timer to determine when to stop measuring the CLI-RSSI resource(s) in a non-active carrier. The WTRU can stop measuring the CLI-RSSI resource(s) if the carrier is not activated by the network and the timer expires. The WTRU may start a timer after receiving an indication to measure the CLI-RSSI resource(s) in the non-active carrier. Upon the expiry of the timer, the WTRU may stop measuring the CLI-RSSI resource(s) in the non-active carrier. In one example solution, the WTRU may reset the timer if the WTRU determines that the measurement result is below or equal to a configured threshold. For example, the WTRU may reset the timer when it measures CLI-RSSI value(s) and determines that the measurement result is below or equal to a configured threshold. In another example solution, the WTRU may reset the timer if the WTRU determines that the measurement result is above a configured threshold. The WTRU may reset the timer when it measures SRS-RSRP and determines that the measurement result is above a configured threshold. In another example, the WTRU may reset the timer when it measures CLI-RSSI and determines that the measurement result is above a configured threshold.

Examples of SRS reception prioritization are provided herein. In some example solutions, a WTRU may be configured to prioritize monitoring between multiple SRS transmissions. For example, the WTRU prioritizes if the WTRU is configured with multiple SRSs overlapping in the time domain, and the WTRU is not capable of monitoring multiple SRSs at the same time. The WTRU may be configured to prioritize monitoring among multiple SRS transmissions based on the carrier index of the SRS resource. For example, in case of overlapping, the WTRU prioritizes SRS transmissions with lower carrier index(es). In another example solution, the WTRU may be configured to prioritize monitoring among multiple SRS transmissions based on the SBFD configuration. For example, the WTRU may be configured to prioritize monitoring SRS on a carrier which has the same SBFD configuration as a PCell SBFD configuration.

Examples of CLI-RSSI measurement prioritization are provided herein. In some example solutions, a WTRU may be configured to prioritize monitoring (for example, measuring) between multiple CLI-RSSI resources. For example, the WTRU may prioritize if the WTRU is configured with multiple CLI-RSSI resources overlapping in the time domain, and the WTRU is not capable of monitoring (for example, measuring) multiple CLI-RSSI resources at the same time. The WTRU may be configured to prioritize monitoring (for example, measuring) among multiple CLI-RSSI resources based on the carrier index of the CLI-RSSI resource. For example, in case of overlapping, the WTRU prioritizes CLI-RSSI measurement(s) with lower carrier index(es). In another example solution, the WTRU may be configured to prioritize monitoring (for example, measuring) among multiple CLI-RSSI resources based on the SBFD configuration. For example, the WTRU may be configured to prioritize monitoring (for example, measuring) CLI-RSSI resources on a carrier which has the same SBFD configuration as a PCell SBFD configuration.

Examples of triggering SRS transmission for cross link evaluation are provided herein. The WTRU may be configured to receive an indication from the network that triggers the transmission of a configured SRS transmission in one or multiple non-activated carriers. For example, the WTRU can receive an RRC signaling that triggers transmission of a configured SRS. In another example, the WTRU can receive a MAC CE that triggers transmission of a configured SRS. The MAC CE can be carried in a PDSCH transmission in an activated carrier. In another example, the WTRU can receive a DCI that triggers transmission of a configured SRS. The DCI can be carried in a PDCCH transmission in another activated carrier. The network indication can trigger the transmission of multiple SRS resources in one carrier and/or multiple carriers. For example, a bitfield in the DCI/MAC CE can trigger multiple SRS transmissions in the same carrier.

Examples of SRS transmission prioritization are provided herein. In some example solutions, a WTRU may be configured to prioritize transmission between multiple SRS transmissions. For example, the WTRU prioritizes if the WTRU is configured with multiple SRSs overlapping in the time domain, and the WTRU is not capable of transmitting multiple SRSs at the same time. The WTRU may be configured to prioritize transmission among multiple SRS transmissions based on the carrier index of the SRS resource. For example, in case of overlapping, the WTRU prioritizes SRS transmissions with lower carrier index(es). In another example solution, the WTRU may be configured to prioritize transmission among multiple SRS transmissions based on the SBFD configuration. For example, the WTRU may be configured to prioritize transmission of SRS on a carrier which has the same SBFD configuration as a PCell SBFD configuration.

Examples of a PUCCH for cross link measurement in a non-active carrier are provided herein. The WTRU may be configured to transmit/receive a PUCCH resource in a non-active carrier for cross link level measurement. The PUCCH resource can be confined within the uplink sub-band of the carrier. The PUCCH frequency resource can be interlaced with other uplink resources. The PUCCH frequency resource can consist of a set of RBs that are spread across the uplink sub-band.

Examples of a PUSCH for cross link measurement are provided herein. The WTRU may be configured to transmit/receive a PUSCH resource in a non-active carrier for cross link level measurement. The PUSCH resource can be confined within the uplink sub-band of the carrier. The PUSCH frequency resource can be interlaced with other uplink resources. The PUSCH frequency resource can consist of a set of RBs that are spread across the uplink sub-band.

Examples of activation of an SBFD carrier are provided herein. In some example solutions, the WTRU may be configured to receive a carrier activation for one or multiple carriers after measuring CLI interference (for example, based on measurements on SRS(s) and/or CLI-RSSI resource(s)) and/or transmitting an uplink transmission (for example, an SRS transmission in a non-active carrier).

Examples of SRS measurement reporting are provided herein. The WTRU may receive a request from the base station or gNB to report the SRS measurement(s) for one or more of non-active carriers. The SRS measurement(s) may include one or more of the following: the RSRP measured on SRS resource(s), such as, SRS-RSRP; or the RSSI measured on SRS resource such as, CLI-RSSI.

In some example solutions, a WTRU may be configured to determine whether to measure SRS-RSRP or CLI-RSSI based on the configured SRS resource format to monitor. For example, based on the total number of PRBs of SRS resource(s), the WTRU determines whether to measure RSRP or RSSI. If the number of PRBs of the SRS resource(s) is above a configured threshold, the WTRU measures RSRP; otherwise, the WTRU measures RSSI. In another example, based on the size of the UL subband in which the SRS resource is monitored, the WTRU determines whether to measure RSRP or RSSI. If the UL subband size is above a configured threshold, the WTRU measures RSSI; otherwise the WTRU measures RSRP. The WTRU may determine whether to measure RSRP or RSSI based on one or a combination of the following: a frequency allocation of SRS resource(s) including a transmission comb; a cyclic shift of the SRS resource; UL subband size on which the SRS resource is configured; or DL subband size on which the SRS resource is configured.

The WTRU may be configured to report the SRS measurement results using an uplink resource on the non-activated carrier(s) for example, a PUCCH resource or PUSCH resource. The WTRU may be configured with uplink resource(s) along with the carrier configuration. Additionally or alternatively, the WTRU may be configured with uplink resource(s) on the non-active carrier when receiving the request for the SRS measurement report.

In another example solution, the WTRU may be configured to report SRS measurement results using an uplink resource on an active carrier(s) for example, a PUCCH resource or PUSCH resource on a PCell. The WTRU may be configured with uplink resource(s) on the PCell when receiving the request for the SRS measurement report.

The WTRU may be configured to report CSI (and/or beam) measurements on non-active carrier(s) upon determining that the SRS measurement results are above a configured threshold. For example, the WTRU may be configured to report SRS measurements results along with the CSI (and/or beam) measurement report in non-active carrier(s).

Examples of CLI-RSSI measurement reporting are provided herein. The WTRU may receive a request from the base station or gNB to report the CLI-RSSI measurement for one or more of non-active carriers, which may be indicated in addition to the above SRS measurement reporting request, where the WTRU may (be configured or indicated to) perform both (or either one) of SRS measurement reporting and CLI-RSSI measurement reporting. The CLI-RSSI measurement may include one or more of the following. The CLI-RSSI measurement may include the RSRP measured on CLI-RSSI resource, such as the CLI-RSSI. Additionally or alternatively, the CLI-RSSI measurement may include a (wideband) RSRP value measured on a CLI-RSSI resource configured with a non-contiguous resource allocation (for example, across two or more DL subbands). Additionally or alternatively, the CLI-RSSI measurement may include a separate one or more (sub-band) RSRP values measured on a CLI-RSSI resource configured with a non-contiguous resource allocation (for example, across two or more DL subbands), where each of the separate RSRP values may be determined based on measuring each DL subband, separately.

The WTRU may be configured to report CSI (and/or beam) measurements on non-active carrier(s) upon determining that the CLI-RSSI measurement results are above a configured threshold. For example, the WTRU may be configured to report CLI-RSSI measurement results along with the CSI (and/or beam) measurement report (and/or SRS measurements results) in non-active carrier(s).

Examples of Cell/carrier ID reporting are provided herein. In some example solutions, the WTRU may be configured to report the ID(s) of the cell(s)/carrier(s) for which SRS-RSRP and/or CLI-RSSI measurement results are below or equal to a configured threshold. In another example solution, the WTRU may be configured to report the ID(s) of the N carriers with the lowest SRS-RSRP and/or CLI-RSSI, where N is indicated by the network. The WTRU may report the carrier/cell ID(s) using a MAC CE, DCI and/or RRC signaling. The WTRU may be configured to report the ID(s) of only the cell(s)/carrier(s) configured with an SBFD configuration.

In some example solutions, the WTRU may be configured to report the ID(s) of the cell(s)/carrier(s) for which SRS-RSRP and/or CLI-RSSI measurement results are above a configured threshold. In another example solution, the WTRU may be configured to report the ID(s) of the N carriers with the highest SRS-RSRP and/or CLI-RSSI, where N is indicated by the network. The WTRU may report the carrier/cell ID(s) using a MAC CE, DCI and/or RRC signaling. The WTRU may be configured to report the ID(s) of only the cell(s)/carrier(s) configured with an SBFD configuration.

Examples of an activation of a configured carrier from the network are provided herein. In some example solutions, a WTRU may be configured to receive an activation command of one or multiple carriers after reporting the SRS measurement results, the CLI-RSSI measurement results, and/or cell/carrier ID(s). The WTRU may be configured to monitor the activation command in a time window after sending SRS measurement results, the CLI-RSSI measurement results, and/or cell/carrier ID(s). For example, the WTRU may be configured with a search space set for PDCCH monitoring that is only monitored by the WTRU after reporting SRS measurement results, the CLI-RSSI measurement results, and/or cell/carrier ID(s). Such search space can be configured in an active carrier or alternatively in a non-active carrier for which the measurement result the WTRU is reporting.

In some example solutions, the WTRU may be configured by the network to activate a subset (or currently configured all) of UL-subbands of the carrier when activating the carrier. For example, the carrier is configured with 4 UL subbands and the WTRU receives an indication from the network to activate only one UL subband. For example, the carrier is (already) configured with 4 UL subbands (for example, when the carrier (SCell) is configured) and the WTRU receives an indication from the network to activate all 4 UL subbands but without activating DL subband(s).

In another example solution, the WTRU may be configured by the network to activate a subset (or currently configured all) of DL-subbands of the carrier when activating the carrier. For example, the carrier is configured with 2 DL subbands and the WTRU receives an indication from the network to activate only one DL subband. For example, the carrier is (already) configured with 2 DL subbands (for example, when the carrier (SCell) is configured) and the WTRU receives an indication from the network to activate all 2 DL subbands but without activating UL subband(s). The WTRU may be configured by the network to activate the sub-set of UL/DL subbands during certain slots/symbols. For example, the WTRU deactivates the sub-set of UL/DL subbands outside the indicated slots/symbols.

In some example solutions, a WTRU may be configured to activate a non-active carrier without SBFD configuration. For example, the WTRU is configured to transmit SRS and/or monitor SRS (and/or measure CLI-RSSI resource(s)) in non-active carrier(s) with SBFD configuration. After transmitting and measuring the SRS transmission (and/or CLI-RSSI resource(s)), the WTRU reports to the network the measurement reports. The base station or gNB can then determine that the WTRU should not be configured with SBFD on that carrier and instead activate the carrier without SBFD configuration.

Examples of autonomous activation of a configured carrier are provided herein. In some example solutions, a WTRU may be configured to autonomously activate a carrier after determining that SRS-RSRP and/or CLI-RSSI measurement results are below a configured threshold. In one example, the WTRU may be configured to first report the SRS measurements/list (and/or CLI-RSSI measurements/list) of carrier ID(s) to the network and then activate the carrier. In another example, the WTRU may be configured to activate the carrier without reporting the SRS (and/or CLI-RSSI) measurement results to the network. The WTRU can then transmit an uplink transmission to indicate to the network that the carrier was activated by the WTRU. The WTRU may monitor the downlink scheduling for the autonomously activated carrier after activating it. If the WTRU does not receive any scheduling from the network on the activated carrier for a configured period of time, the WTRU deactivates the carrier. If the WTRU receives scheduling information from the network on the activated carrier, the WTRU keeps the carrier active and monitors downlink transmissions.

In some example solutions, the WTRU may autonomously activate a subset (or all) of UL-subbands of the carrier when activating the carrier. For example, the carrier is configured with 4 UL subbands and the WTRU activates only one UL subband. In another example solution, the WTRU may autonomously activate a subset (or all) of DL-subbands of the carrier when activating the carrier. For example, the carrier is configured with 2 DL subbands and the WTRU activates only one DL subband. The WTRU may activate the sub-set of UL/DL subbands during certain slots/symbols. The WTRU may indicate to the network the activated carriers and/or UL/DL subbands using an uplink transmission. The WTRU can be configured with a resource (for example, a PUSCH, PUCCH or PRACH resource) within a non-active carrier and/or UL sub-band that can be used to indicate to the network that the carrier was activated autonomously by the WTRU. For example, a non-active carrier is configured with two UL sub-bands (UL sub-band 1 and UL sub-band 2) and within each sub-band, the WTRU is configured with an uplink resource. After performing SRS measurements (and/or CLI-RSSI measurements), the WTRU autonomously activates UL sub-band 2 of the carrier. The WTRU transmits the configured uplink resource in UL sub-band 2 to indicate to the network that the UL sub-band 2 of the carrier is activated.

The base station or gNB may acknowledge the carrier/UL sub-band activation using a downlink transmission. The downlink transmission from the base station or gNB acknowledging the autonomously carrier activation by the WTRU can be one or more of the following. The acknowledging downlink transmission may be a PDDCH transmission. For example, the acknowledging downlink transmission may be a PDCCH scheduling uplink/downlink transmission in the autonomously activated carrier/UL-subband(s)/DL-subband(s). Additionally or alternatively, the acknowledging downlink transmission may be a CSI-RS transmission. For example, acknowledging downlink transmission may be an aperiodic CSI-RS transmission can be configured for the WTRU in a non-active carrier. When the WTRU activates a carrier, the WTRU starts to monitor the CSI-RS to determine if the base station or gNB acknowledges the autonomous carrier activation. Additionally or alternatively, the acknowledging downlink transmission may be a PDSCH transmission. For example, the WTRU may be configured with a downlink semi-persistent (SPS) transmission in a non-active carrier. Upon activating a carrier, the WTRU starts monitoring the DL SPS and if it successfully decodes the DL SPS, the WTRU keeps the carrier active. Otherwise, the WTRU deactivates the carrier.

The WTRU may be configured to wait for base station or gNB acknowledgement of the autonomously activated carrier/UL subband/DL subband for a configured period of time after activating the carrier/UL subband/DL subband. The WTRU can start a timer after activating the carrier/UL subband/DL subband. After timer expiry, the WTRU deactivates the carrier if no acknowledgement is received from the network.

Examples of multiple associated configured carriers are provided herein. In some example solutions, a WTRU may be configured with multiple carriers that are associated with each other. Upon activating/deactivating one carrier, the WTRU activates/deactivate the carrier(s) associated with the carrier. For example, a WTRU is configured with four carriers (for example, carriers 1, 2, 3 and 4). If the WTRU activates carrier 1 then it will also activate carriers 2, 3 and 4. The WTRU can be configured with the association explicitly from the network. Additionally or alternatively, the WTRU may associate the carriers with the same SBFD configuration. For example, if two carriers have the same SBFD configuration, the WTRU activates the two carriers whenever the WTRU determines that one of the carriers should be activated. The WTRU deactivates the two carriers whenever the WTRU determines that one of the carriers should be deactivated.

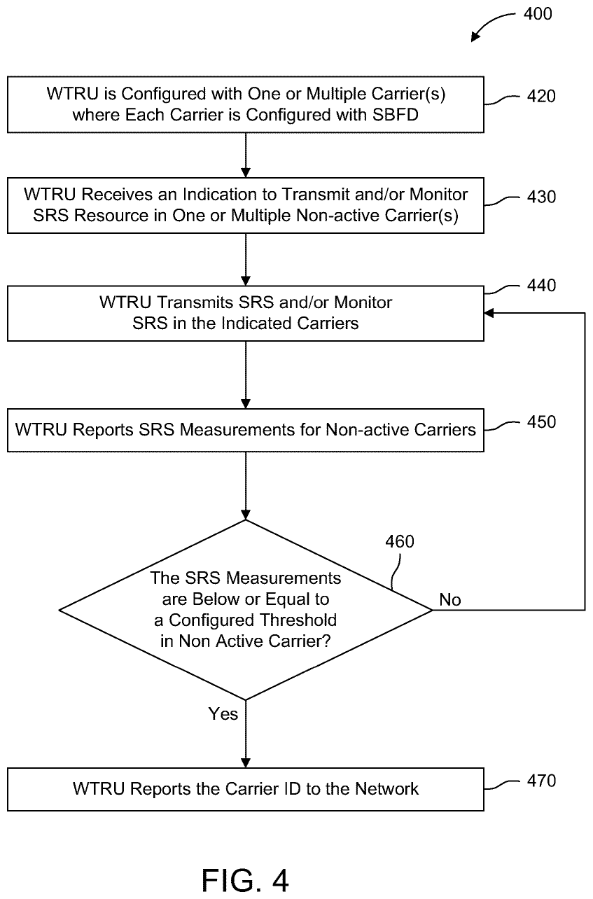

FIG. 4 is a flowchart diagram illustrating an example of preventing the activation of a carrier for a WTRU which will create a high level of CLI to other WTRUs. As shown in an example in flowchart diagram 400, a WTRU is configured with one or multiple carriers 420. In an example, each carrier is configured with SBFD. For example, the WTRU receives a configuration from the network configuring one or more carriers with one or more time units which use SBFD. Additionally or alternatively, the WTRU using carrier aggregation with multiple carriers, including a PCell and secondary cells or secondary carriers.

Further, the WTRU receives an indication to transmit an SRS transmission in one or more SRS resources in one or multiple non-active carriers 430. Additionally or alternatively, the WTRU receives an indication monitor for an SRS transmission in one or more SRS resources in one or multiple non-active carriers. Accordingly, the WTRU transmits an SRS transmission in the indicated one or more SRS resources in the indicated one or multiple non-active carriers 440. Additionally or alternatively, the WTRU monitors for an SRS transmission in the indicated one or more SRS resources in the indicated one or multiple non-active carriers.

The WTRU reports 450 SRS measurements in non-active carriers. In an examples, the WTRU SRS measurements are based on the monitored one or more SRS resources.

Moreover, the WTRU will then determine if one or more of the SRS measurements are below or equal to a configured threshold in a non-active carrier 460. If one or more of the SRS measurements are below or equal to the configured threshold in the non-active carrier, the WTRU will report the carrier ID of the non-active carrier to the network. 470. If the SRS measurements are above the configured threshold in the non-active carrier, the WTRU will continue monitoring for SRS transmissions and measuring SRS.

In an example, the network may continue to keep the non-active carrier in a non-activated state, deactivated state, or a not enabled state for the WTRU. This way, the carrier is prevented from possibly causing CLI to other WTRUs.

In an example, a WTRU receives one or more configuration information messages regarding one or more SBFD carriers, including SBFD configuration information, wherein the SBFD configuration information includes, for each of the one or more SBFD carriers: time units; one or more downlink subbands, uplink subbands, or both, for each of the times units; an SRS configuration for reception; and an SRS configuration for transmission. The WTRU further receives indication information regarding SRS resources for one or more non-activated carriers of the one or more SBFD carriers.

The WTRU then monitors one or more first SRSs associated with the one or more non-activated carriers, based on the respective SRS configuration for reception of each of the non-activated carriers and the indication information. Also, the WTRU transmits one or more second SRSs associated with the one or more non-activated carriers, based on the respective SRS configuration for transmission of each of the non-activated carriers and the indication information.

In addition, the WTRU receives a request to report SRS measurements for the one or more first SRSs associated with the one or more non-activated carriers. Moreover, the WTRU reports a set of carriers, of the one or more non-activated carriers, with SRS measurements for the one or more first SRSs associated with the one or more non-activated carriers with results below or equal to a threshold.

In a further example, the indication information is received via RRC signaling. Additionally or alternatively, the indication information is received via a MAC CE. Additionally or alternatively, the indication information is received via DCI.

In another example, the SRS measurements include one or more SRS-RSRP measurements. Additionally or alternatively, the SRS measurements include CLI-RSSI measurements.

In a further example, the WTRU receives configuration information regarding reporting the SRS measurements using an uplink resource within a non-activated carrier of the one or more non-activated carriers, wherein the SRS measurements are reported, based on the configuration information regarding reporting the SRS measurements, using the uplink resources within the non-activated carrier of the one or more non-activated carriers. Additionally or alternatively, the WTRU receives configuration information regarding reporting the SRS measurements using an activated carrier, wherein the SRS measurements are reported, based on the configuration information regarding reporting the SRS measurements, using the activated carrier.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for used in a wireless transmit/receive unit (WTRU), the method comprising:
receiving one or more configuration information messages regarding one or more sub-band full duplex (SBFD) carriers, including SBFD configuration information, wherein the SBFD configuration information includes, for each of the one or more SBFD carriers: a sounding reference signal (SRS) configuration for reception, and an SRS configuration for transmission;
receiving indication information regarding SRS resources for one or more non-activated carriers of the one or more SBFD carriers;
monitoring one or more first SRSs associated with the one or more non-activated carriers, based on the respective SRS configuration for reception of each of the one or more non-activated carriers and the indication information;
transmitting one or more second SRSs associated with the one or more non-activated carriers, based on the respective SRS configuration for transmission of each of the one or more non-activated carriers and the indication information;
receiving a request to report SRS measurements for the one or more first SRSs associated with the one or more non-activated carriers; and
reporting a set of carriers, of the one or more non-activated carriers, with SRS measurements for the one or more first SRSs associated with the one or more non-activated carriers with results below or equal to a threshold.

2. The method of claim 1, wherein the indication information is received via radio resource control (RRC) signaling.

3. The method of claim 1, wherein the indication information is received via a medium access control (MAC) control element (CE).

4. The method of claim 1, wherein the indication information is received via downlink control information (DCI).

5. The method of claim 1, wherein the SRS measurements include one or more SRS-reference signal received power (RSRP) measurements.

6. The method of claim 1, wherein the SRS measurements include cross link interference (CLI)-reference signal strength indicator (RSSI) measurements.

7. The method of claim 1, further comprising:
receiving configuration information regarding reporting the SRS measurements using an uplink resource within a non-activated carrier of the one or more non-activated carriers, wherein the SRS measurements are reported, based on the configuration information regarding reporting the SRS measurements, using the uplink resources within the non-activated carrier of the one or more non-activated carriers.

8. The method of claim 1, further comprising:
receiving configuration information regarding reporting the SRS measurements using an activated carrier, wherein the SRS measurements are reported, based on the configuration information regarding reporting the SRS measurements, using the activated carrier.

9. The method of claim 1, wherein the SBFD configuration information further includes, for each of the one or more SBFD carriers:
(i) time units; and
(ii) for each of the times units: one or more downlink subbands, one or more uplink subbands, or one or more downlink subbands and one or more uplink subbands.

10. A wireless transmit/receive unit (WTRU) comprising:
a transceiver; and
a processor, operatively coupled to the transceiver; wherein:
the transceiver is configured to receive one or more configuration information messages regarding one or more sub-band full duplex (SBFD) carriers, including SBFD configuration information, wherein the SBFD configuration information includes, for each of the one or more SBFD carriers: a sounding reference signal (SRS) configuration for reception, and an SRS configuration for transmission;
the transceiver is configured to receive indication information regarding SRS resources for one or more non-activated carriers of the one or more SBFD carriers;
the transceiver and the processor are configured to monitor one or more first SRSs associated with the one or more non-activated carriers, based on the respective SRS configuration for reception of each of the one or more non-activated carriers and the indication information;
the transceiver and the processor are configured to transmit one or more second SRSs associated with the one or more non-activated carriers, based on the respective SRS configuration for transmission of each of the one or more non-activated carriers and the indication information;
the transceiver is configured to receive a request to report SRS measurements for the one or more first SRSs associated with the one or more non-activated carriers; and
the transceiver and the processor are configured to report a set of carriers, of the one or more non-activated carriers, with SRS measurements for the one or more first SRSs associated with the one or more non-activated carriers with results below or equal to a threshold.

11. The WTRU of claim 10, wherein the indication information is received via radio resource control (RRC) signaling.

12. The WTRU of claim 10, wherein the indication information is received via a medium access control (MAC) control element (CE).

13. The WTRU of claim 10, wherein the indication information is received via downlink control information (DCI).

14. The WTRU of claim 10, wherein the SRS measurements include one or more SRS-reference signal received power (RSRP) measurements.

15. The WTRU of claim 10, wherein the SRS measurements include cross link interference (CLI)-reference signal strength indicator (RSSI) measurements.

16. The WTRU of claim 10, wherein the transceiver is further configured to receive configuration information regarding reporting the SRS measurements using an uplink resource within a non-activated carrier of the one or more non-activated carriers, wherein the SRS measurements are reported, based on the configuration information regarding reporting the SRS measurements, using the uplink resources within the non-activated carrier of the one or more non-activated carriers.

17. The WTRU of claim 10, wherein the transceiver is further configured to receive configuration information regarding reporting the SRS measurements using an activated carrier, wherein the SRS measurements are reported, based on the configuration information regarding reporting the SRS measurements, using the activated carrier.

18. The WTRU of claim 10, wherein the SBFD configuration information further includes, for each of the one or more SBFD carriers:
(i) time units; and
(ii) for each of the times units: one or more downlink subbands, one or more uplink subbands, or one or more downlink subbands and one or more uplink subbands.
